(19) United States
(12) Patent Application Publication
(10) Pub. No.: US 2025/0173574 A1
(43) Pub. Date: May 29, 2025

(54) DOMAIN-SPECIFIC LANGUAGES FOR USE IN ARTIFICIAL INTELLIGENCE

(71) Applicant: Jaxon, Inc., Boston, MA (US)

(72) Inventors: Robert Jones, Williamsburg, VA (US); Gregory Harman, Castro Valley, CA (US)

(73) Assignee: Jaxon, Inc., Boston, MA (US)

(21) Appl. No.: 18/955,116

(22) Filed: Nov. 21, 2024

Related U.S. Application Data
(60) Provisional application No. 63/603,308, filed on Nov. 28, 2023.

(51) Int. Cl. G06N 3/09; G06F 40/20; G06F 40/58; G06N 3/0475

(52) U.S. Cl. CPC G06N 3/09; G06F 40/20; G06F 40/58; G06N 3/0475

(57) ABSTRACT

Domain-specific computer languages (DSL's) 22, such as DSAIL (Domain-Specific Artificial Intelligence Language) are used as bridges for combining the best attributes of generative AI models 21 such as Large Language Models (LLM's) with formal reasoning systems such as logical solvers 25, to combat hallucinations that can be introduced by the LLM's 21 and to automate the process of discovering alternative solutions to problems posed by human users 2. The creativity of the LLM's 21 and the rigorous validation provided by the logical solver(s) 25 are thus both present in the solutions produced by the generative AI. The DSL 22 and a Model of Computation module 24 function as the primary means of communication between the AI model 21 and the solver(s) 25.

### RELATED PATENT APPLICATIONS

The present patent application claims the priority benefit of commonly-owned U.S. provisional patent application 63/603,308 filed Nov. 28, 2023 entitled “Domain Specific AI Language (DSAIL)” (Attorney Docket JAXN 0594 PR); said provisional patent application 63/603,308 and commonly-owned U.S. patent application Ser. No. 18/413,670 filed Jan. 16, 2024 entitled “AutoSpec” (Attorney Docket JAXN 0582 US) are hereby incorporated by reference in their entireties into the present patent application.

### FIELD OF THE INVENTION

The present invention pertains to the field of improving the results of generative artificial intelligence. The improvements include minimizing hallucinations and automating the process of discovering alternative solutions to natural language problems that are posed by human users.

### BACKGROUND OF THE INVENTION

In the realm of artificial intelligence (AI), particularly within the domain of Large Language Models (LLMs), the phenomenon known as “hallucination” presents a significant challenge. This issue arises when generative AI models such as LLMs, despite their advanced algorithms and extensive training on large datasets, generate responses that are either factually incorrect, nonsensical, or disconnected from the input provided. The term “hallucination” in this context reflects the model's tendency to imagine or fabricate information, rather than relying solely on the model's training data and the input the model has received. This problem not only undermines the reliability and trustworthiness of generative AI outputs, but also poses substantial barriers to the practical application of these models in critical decision-making processes. As generative AI models become increasingly integrated into various sectors of modern life, from customer service to content creation, addressing the hallucination issue becomes paramount to ensure effective and accurate utilization of artificial intelligence.

In contrast to the generative prowess of generative AI models such as Large Language Models (LLMs), logical solvers such as SAT (Boolean SATisfiability problem solvers) and SMT (Satisfiability Modulo Theory solvers) operate within a fundamentally different paradigm. Logical solvers are designed to rigorously assess the feasibility or truth of logical statements, often in highly structured and rule-bound environments. The strength of logical solvers lies in the realm of formal verification, where they can conclusively prove or disprove propositions within a given set of constraints. However, unlike LLMs, SAT and SMT solvers lack generative capabilities; they are not equipped to create novel content or responses. They operate in a binary world of mathematical certainty, devoid of the creativity and fluidity inherent in language models. This dichotomy highlights a crucial gap in the AI landscape: while logical solvers like SAT and SMT excel in formal proof and validation, they are unable to match the creative and generative flexibility of LLMs, which, conversely, struggle with ensuring factual accuracy and consistency in their outputs.

What is needed are inventive solutions to blend the logical verification strengths inherent in logical solvers with the dynamic content generation of artificial intelligence engines. It is an object of the present invention to provide such solutions. It is a further object of the present invention to minimize the incidence of hallucinations. It is a still further object of the present invention to automate the process of providing alternative solutions to the same problem, and solutions to related problems that are posed to artificial intelligence engines by human users.

### SUMMARY OF THE INVENTION

The present invention comprises systems and methods for improving the performance of generative artificial intelligence. A system embodiment of the present invention comprises a generative AI engine 21 configured to convert natural language input 31 into a domain-specific computer language 22; coupled to the domain-specific computer language 22, a model of computation module 24; and coupled to the model of computation module 24, at least one logical solver configured to assess the truth and feasibility of logical statements contained in the domain-specific computer language 22; wherein the at least one logical solver 25 is further configured to provide feedback to the generative AI engine 21.

### BRIEF DESCRIPTION OF THE DRAWINGS

These and other more detailed and specific objects and features of the present invention are more fully disclosed in the following specification, reference being had to the accompanying drawings, in which:

FIG. 1 is an overview of a Model of Computation (MoC) 24 suitable for use in the present invention.

FIG. 2 is a block diagram of an embodiment of the present invention, where the interconnections between blocks represent method steps for carrying out the invention.

FIG. 3 is a more detailed block diagram of the FIG. 2 embodiment.

FIG. 4 is more detailed block diagram of the embodiments of the present invention shown in FIGS. 2 and 3.

### DETAILED DESCRIPTION OF PREFERRED EMBODIMENTS

The present invention combines a generative AI engine 21, such as an LLM, with one or more logical solvers 25. In particular, we introduce the following items:

A domain-specific computer language (DSL) 22, a tailored computer language used to facilitate the interface between the generative AI engine 21 and the one or more logical solvers 25. A separate DSL 22 is preferably created for each different operating domain of interest, allowing superior complexity and precision when expressing and solving natural language problems by the present invention. As used herein, “domain” means a particular field of endeavor that a human user 2 is interested in. The domain can be a business domain, a scientific domain, a hobby domain, etc.

A Model of Computation (MoC) 24. Use of a DSL 22 (and its associated DSL compiler 23) allows the flexibility to use an abstracted, graph-based Model of Computation 24, which can be empowered by graph analysis and a variety of logical solvers 25.

A Knowledge Store 26. An optional Knowledge Store 26 allows external facts to be included in the MoC 24 without the need for these facts to be explicitly stated by the user 2 with each problem submitted to the AI engine 21 by the user 2. Example implementations of Knowledge Store 26 include ontological description logic 27, a knowledge triple store, a knowledge graph (KG), and a vector database (DB). The computer implementing the present invention can tier groups of facts based upon confidence levels, thus informing MoC 24 on how strongly to consider each individual fact. As one example, three tiers of facts can be present in Knowledge Store 26, corresponding to user-sourced facts, validated-as-truth facts (e.g., validated by a neural network as ground truth), and LLM-sourced provisional information. These confidence levels, particularly when facts and provisional information are in conflict with one another, can be calculated and updated to account for new facts or provisional information using Bayesian inference and belief propagation. Bayes' rule is a formula used to describe the principle that updates the probability estimates for a hypothesis as more evidence or information becomes available.

To expand on the concepts of Bayesian inference and belief propagation in relation to Knowledge Store 26, we can delve into how these methodologies play a crucial role in managing, updating, and reasoning over the hierarchical tiers of facts.

Bayesian Inference for Confidence Levels: Bayesian inference provides a systematic framework for updating the probability of a hypothesis (in this case, the validity of a fact in Knowledge Store 26) as new evidence is introduced. In the context of Knowledge Store 26, we have:

User-sourced facts: These facts are directly supplied by User 2 and may be associated with an initial high confidence level unless contradicted by validated or provisional information.

Validated-as-truth facts: These facts, deemed reliable through independent verification (e.g., validated as ground truth by a neural network or by external review), inherently carry higher confidence. Bayesian inference can integrate these into Knowledge Store 26 by adjusting the confidence of other related facts.

LLM-sourced provisional information: Provisional facts generated by a large language model (such as AI engine 21) often start with lower confidence and require Bayesian updates based on additional evidence, such as corroboration from validated facts or feedback from user queries.

Belief Propagation Across Knowledge Graphs: When facts in Knowledge Store 26 are represented as nodes in a knowledge graph, with relationships modeled as edges, belief propagation allows for the iterative updating of confidence levels across interconnected nodes. This approach is especially valuable when conflicts arise between user-sourced facts and provisional information. Propagation ensures that changes in confidence for one fact can cascade to adjust related facts proportionally.

New evidence introduces dependencies across multiple facts. For example, if a high-confidence validated fact supports a provisional one, the latter's confidence is increased through propagation.

The system integrates new facts into the graph. Propagation ensures that all related nodes are dynamically updated, maintaining coherence within the knowledge graph.

Tiered Bayesian Updates in Practice: Knowledge Store 26 implements a tiered update mechanism informed by Bayesian principles.

Prior Probability Assignment: Each fact is initially assigned a confidence level based on its source (e.g., user-sourced facts may have a default a priori probability of 0.7, while LLM-sourced facts may start at 0.5).

Likelihood Calculation: When new evidence is added to MOC 24, the likelihood of this evidence being consistent with existing facts is calculated. For example, if a new LLM-sourced fact aligns with a validated fact, the likelihood is high.

Posterior Update: Using Bayes' rule, the posterior confidence for each fact is updated, factoring in both the prior probability and the likelihood of the evidence.

Resolving Conflicts: When facts at different tiers conflict, Bayesian inference ensures that higher-confidence facts (e.g., validated ground truth) dominate in the probability update. Belief propagation further reconciles related facts by spreading the influence of the higher-confidence fact throughout the knowledge graph. This process dynamically adjusts the weight of conflicting information and maintains a consistent knowledge base.

Dynamic Adaptation with New Data: As Knowledge Store 26 incorporates additional data from user queries, external validation, or iterative reasoning cycles, Bayesian inference ensures continuous refinement of confidence levels. Belief propagation guarantees that the updates remain consistent and integrated across the entire knowledge graph.

Iterative improvement: Instead of sourcing all candidate solutions with User 2 needing to be directly involved in each iteration, we can use AI engine 21 to generate and refine candidate solutions which the logical solver(s) 25 then validate, based on user-provided constraints, requirements, and assertions. This enables automated exploration and expansion of the solution space corresponding to the natural language problem 31 presented to the generative AI engine 21.

This automated exploration of the solution space in turn supports preemptive exploration of adjacent (similar) problems, with the most promising solutions archived as initial starting points for subsequent iterations. These new solutions can be retrieved from the archive using, e.g., RAG (Retrieval Augmented Generation) by engine 21, or retrieved with other similarity metrics by MoC 24.

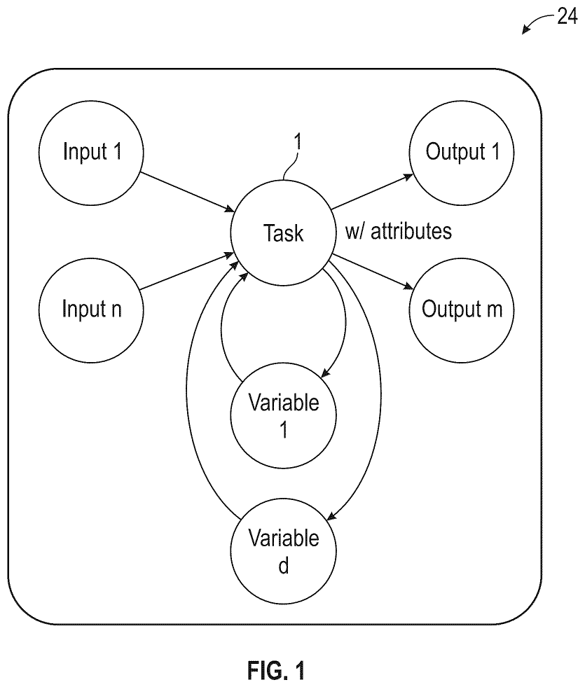

FIG. 1 shows an overview of a suitable MoC 24 for use in the present invention. Inputs to and outputs from the task 1 performed by the MoC 24 are data variables that can be defined with metadata; and internal variables (using var statements) are state variables that can be read and written (updated). These variables are used by the logical solver(s) 25 associated with MoC 24 in assessing whether the logical constraints have been satisfied.

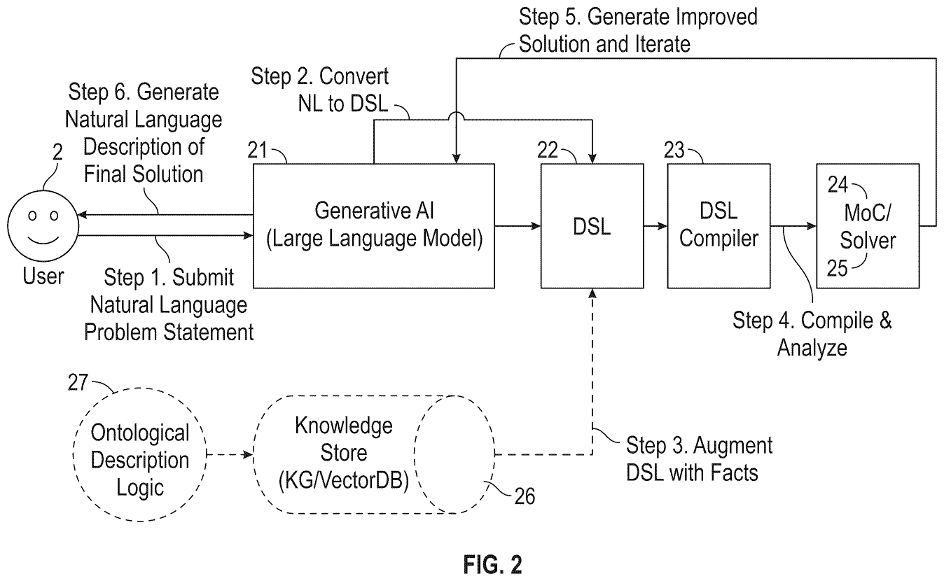

FIG. 2 shows the basic building blocks 21-27 of an embodiment of the present invention. The interconnections between the blocks 21-27 are a series of automated steps that illustrate the overall flow of the corresponding computer-implemented method of the present invention. These method steps will now be described in detail.

Step 1. The user 2 poses a problem statement 31 in a natural language such as English. The problem statement 31 typically includes constraints and requirements and, optionally, a proposed solution. User 2 sends the problem statement 31 to generative artificial intelligence engine 21, which in the illustrated embodiments is a Large Language Model (LLM). If the user 2 does not propose a solution, LLM 21 generates its own proposed solution.

Step 2. LLM 21 converts (translates) the natural language statement 31 that LLM 21 has received in Step 1, and any proposed solution, into a domain-specific computer language (DSL) 22 that is understandable to the computer that executes the method steps of the present invention. Note that advanced users 2 can choose to bypass Step 1 and write the problem statement directly in DSL 22, or can review and edit the DSL 22 generated by LLM 21 before the computer-automated method proceeds to Step 3. Such bypassing is typically done to avoid the introduction of excess noise/inaccuracy in translation Step 2 and/or to ensure that DSL 22 completely represents the intent of user 2.

Aside from the direct translation by LLM 21 of the entirety of the inputted user-generated natural language 31 into DSL 22 in a single step, an embodiment of the present invention comprises an optional intermediate two-step process that we dub “PIDGIN”. In this embodiment, the natural language prose 31 inputted by user 2 is first broken down by LLM 21 into a set of discrete declarations. These declarations comprise statements and/or commands. The set of declarations is then converted by LLM 21 into DSL 22 piecemeal, i.e., declaration by declaration. This embodiment can be helpful in certain cases in enabling LLM 21 to better perform its task of converting the inputted natural language 31 into DSL 22.

Step 3. A knowledge store 26, practically implemented as ontological description logic 27, a knowledge triple store, a knowledge graph (KG), a vector database (DB), or other source containing additional assertions (facts), is optionally used in certain embodiments of the present invention. These additional facts are used to augment DSL 22, and can be grouped into a tiered set of confidence levels. Information in knowledge store 26 can be accessed by DSL 22 using retrieval augmented generation (RAG) from the inputted natural language 31 and/or by direct query from the generated DSL 22.

Step 4. The DSL 22 is compiled by DSL compiler 23 into a form that is understandable to the Model of Computation (MoC) 24 and is analyzed by one or more logical solvers 25 that are associated with MoC 24. MoC 24 is implemented as a labeled property graph in an instantiation of the present invention that we have built. Assertions and predicates contained in the DSL 22, and their equivalent in the MoC 24, are assessed for truth and feasibility by the solver(s) 25, and a report of successes and failures is produced by solver(s) 25 by comparing the assertions and predicates against the built-in logic of the solver(s) 25. Suitable solvers 25 are SAT (Boolean SATisfiability) solvers, SMT (Satisfiability Modulo Theory) solvers, and certain graphical transformation algorithms. The satisfiability decision problems solved by the solvers 25 are NP-complete problems, i.e., problems that are at least as hard as the hardest problems in NP (nondeterministic polynomial) space, and therefore require special treatment in practice.

Step 5. The report produced by solver(s) 25 is fed back by solver(s) 25 to LLM 21 with instructions to create an improved version of the prior DSL 22 solution that was outputted by LLM 21. This report addresses any logical failures that were detected by the solver(s) 25. Solutions archived from a previous execution of the present invention, or solutions manually archived by user 2, may also be used in lieu of executing another iteration of the method of the present invention.

Step 6. When all the constraints imposed by user 2 have been satisfied, or when any preselected iteration limit has been reached, the final artificially intelligent solution is translated back into natural language by LLM 21 and returned to user 2.

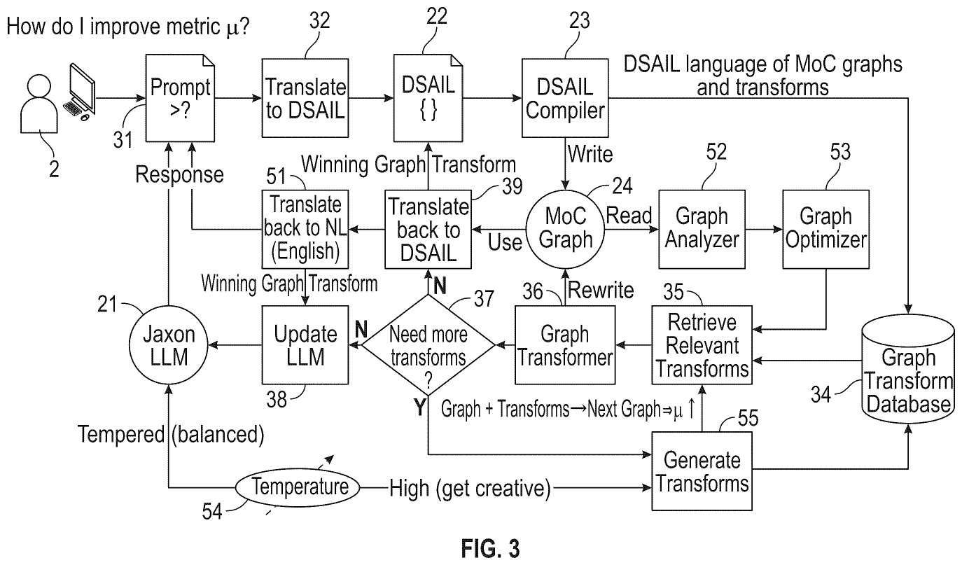

FIG. 3 is a more detailed illustration of the invention that is described in FIG. 2, in which Generative AI module 21 is a LLM (called Jaxon LLM after the name of the assignee) and DSL 22 is DSAIL (Domain-Specific Artificial Intelligence Language). DSAIL 22 is a custom DSL 22 we have crafted to solve problems in the domain of software architecture design.

The method steps underlying the drawing Figures can be performed on any digital computer. The various modules shown in the drawing Figures can be implemented in any combination of hardware, software, and firmware.

At a high level, the FIG. 3 embodiment is still, like the FIG. 2 embodiment, a closed-loop system where user prompts 31 are translated by modules 32 and 23 into graph-based computations 24 that adhere to the DSAIL 22 framework and definitions. Through iterative transformations and optimizations performed on the MoC graph 24, the system enhances, in the illustrated embodiment, a performance metric (\mu), updating LLM 21 with improved knowledge. LLM 21 then relays the responses back to User 2 in natural language.

Temperature setting 54 provides a mechanism by which User 2 can adjust the system's LLM 21-based exploration-exploitation balance, affecting how conservatively or creatively transformations are applied. In the context of the present invention, “temperature” refers to a hyperparameter that controls the randomness versus creativity of LLM 21's responses.

The process begins with a user input or “prompt” 31, where the human user 2 queries the system in a natural language (e.g., English, Spanish, etc.). In the example of FIG. 3, the user prompt 31 can be: “How do I improve metric (\mu)?”.

Prompt 31 is translated into DSAIL 22 by DSAIL translation module 32. DSAIL 22 is particularly useful for describing and manipulating graphs like MoC graph 24.

The translated prompt is converted by DSAIL module 22 into a format that DSAIL compiler 23 can process.

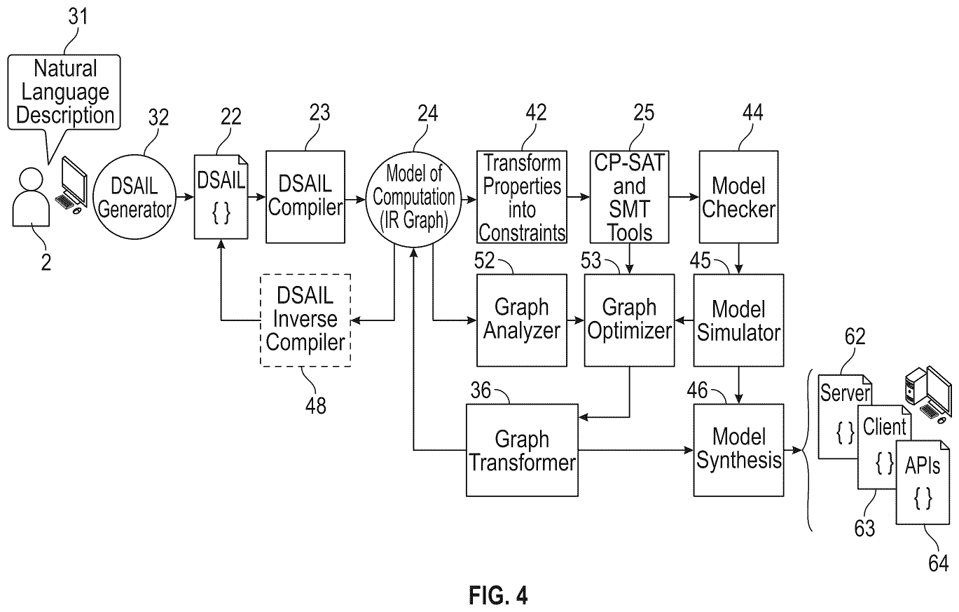

DSAIL compiler 23 generates the MoC Graph 24, a Model of Computation graph that encapsulates the relationships and transformations associated with prompt 31. MoC 24 is implemented in the illustrated embodiment as a graph analysis solver. MOC 24 makes use of one or more SAT/SMT logical solvers 25 to perform its analysis. The logical solvers 25 are not expressly shown in FIG. 3, but are shown in FIG. 4.

MOC Graph 24 is analyzed by graph analyzer 52 and optimized by graph optimizer 53, as first steps in determining the optimal transformations that will improve metric (\mu).

Differences between solutions (i.e., across iterations of the present invention) are formally captured, in a preferred embodiment of the present invention, as Transforms (Transformations), which describe the pattern of change between solutions. Transformations are described in detail in the aforementioned commonly-owned U.S. patent application Ser. No. 18/413,670 filed Jan. 16, 2024, which patent application is incorporated by reference in its entirety into the present patent application. That patent application describes a configuration in which, in a graph comprising a plurality of nodes and a plurality of edges connecting the nodes, each node produces at least one outbound feature, and each edge presents a set of features. The graph can be reconfigured by applying a Transform operation to the graph. LLM 21 can be programmed to generate either full solutions or candidate transformations to apply to existing solutions.

The system retrieves relevant transformations from Graph Transform Database 34 using Retrieval Module 35. Relevancy is determined by the system computer analyzing the transforms obtained from Graph Transform Database 34 via their graph structure and/or stored metadata in order to filter and select those transforms that are expected to have a directional impact on metric (\mu). Graph Transform Database 34 stores successful transformations for future reuse. Storing transformations in this manner is an efficient alternative to storing full solutions, allowing architectural change patterns to be applied to different solutions, while conserving resources. Graph Transform Database is fed by DSAIL Compiler 23.

If needed, additional transformations are generated by Transform Generation Module 55, which sends the additional transformations to Graph Transform Database 34 and to Graph Transformer 36 via Retrieval Module 35. These new transformations may be generated by invoking preselected rules and/or machine learning models tailored to optimize graph 24 in terms of metric (\mu). One such example of this generation is to prompt an LLM 21 with instructions to generate a new transform with a specific goal in mind, optionally providing existing transforms as seed examples. In this scenario, LLM 21 may be additionally instrumented as an agent, with external tools such as code interpreters. These tools can be used by the LLM 21 to perform simulations of candidate transforms to refine the generated results.

Graph Transformer 36 applies the retrieved and/or the newly generated transformations to MOC graph 24, thereby iteratively modifying graph 24.

Decision Node 37, based upon an examination of the transformations presented to Decision Node 37 by Graph Transformer 36, determines if more transformations are needed for further optimization. This determination may be made when a stated value or range of metric (\mu) has been achieved, or when a preselected maximum number of iterations has been reached. If the determination by Node 37 is yes (Y), meaning more transformations are needed, the method cycles back to Transform Generation Module 55 to continue retrieving (by Module 55 accessing Database 34) and/or generating additional transformations. If the determination by Node 37 is no (N), the method proceeds to update LLM 21 with the new information via Updating Module 38, and by Node 37 sending the new information to DSAIL Translation Module 39, which translates the information into DSAIL 22.

A no (N) decision by Node 37 indicates that MOC Graph 24 has been optimized, and a winning set of graph transformations has been selected.

The result in DSAIL 22 format is sent from Module 39 to Translation Module 51, and is translated by Translation Module 51 from DSAIL 22 format back to natural language. Then Module 51 provides a response to user 2 re the original query made by user 2 about metric (\mu) improvement.

The parameter Temperature 54 tempers the stochastic nature of LLM 21. This Temperature 54 control adjusts the “creativity” or variability of the transformations, depending on whether the User 2 wants the output to be more balanced (tempered; corresponding to a low temperature) or more creative (corresponding to a high temperature). A high temperature may be selected to encourage novel solutions, while accepting the risk that such solutions may be less reliable than would be the case if a low temperature were selected. The desired temperature is fed to LLM 21 and to Transform Generation Module 55.

In FIG. 3, the control thread for DSAIL 22 comprises items 32, 23, and 24. The control thread for the MoC graphical analysis comprises items 52, 53, 36, 35, 34, and 55. The control thread for LLM 21 comprises items 21, 51, 39, 38, and 54.

FIG. 4 illustrates additional details found in some embodiments of the present invention, as follows:

Refining FIG. 3 with additional details found in some embodiments of the present invention, FIG. 4 illustrates a comprehensive workflow for transforming natural language descriptions 31 into a computational model using the DSAIL 22 framework, highlighting the integration of domain-specific graph transformations, constraint solvers 25, and simulation tools 45 to synthesize deployable artifacts such as server 62, client 63, and API (Application Programming Interface) 64 specifications. This robust end-to-end pipeline ensures high accuracy, flexibility, and usability in designing and implementing complex systems, by leveraging formal graph-based modeling and verification techniques. The following steps describe the process in detail:

Natural Language Input 31: as previously described, the process begins with User 2 providing a natural language description 31 of a system or problem to be solved.

DSAIL Generation 32-22: the natural language input 31 is parsed and transformed by DSAIL Generator 32 into a DSAIL representation 22-a structured domain-specific computer language tailored for describing and manipulating graphs.

DSAIL Compilation 22-23: the DSAIL representation 22 is compiled into the Model of Computation (MoC) 24 as an intermediate representation (IR graph) by DSAIL Compiler 23. This MoC 24 encodes the relationships and properties of the described system or problem.

Transformation of Properties into Constraints 42: the properties encoded in MoC 24 are transformed by Transformation Module 24 into formal logic constraints, which are used in the subsequent formal verification and optimization steps.

Constraint Programming and SAT/SMT Solvers 25: the transformed constraints are processed using CP-SAT and SMT tools 25 (Constraint Programming and Satisfiability Modulo Theories). These tools 25 ensure that the system properties are logically consistent and satisfiable. Tools 25 are used to identify feasible and optimal solutions in the context of the particular domain-specific problem, and formally verify MoC 24 via model checking.

Model Checker 44: the verified constraints are passed by tools 25 to formal Model Checker 44, which rigorously validates the correctness and compliance of the system's behavior as described by MoC 24.

Tools 25 also pass the verified constraints to Graph Optimizer 53. The system iteratively optimizes the IR graph structure 24 by applying advanced techniques such as graph optimization and graph rewriting, with the objective of enhancing performance, correctness, and/or other metrics.

Graph Optimizer passes its output(s) to Graph Transformer 36, which applies any necessary transformations to refine the IR graph 24, thus incorporating feedback that Graph Optimizer has recevied from the optimization performed by Optimizer 53 and the verification performed by Tools 25.

Model Simulator 45 receives the output from Model Checker 44, and simulates the refined IR graph 24 to validate dynamic behaviors and interactions, ensuring that the system operates as expected under various scenarios. Simulator passes results of its simulation to Graph Optimizer 53 and to Model Synthesis Module 46.

Model Synthesis Module 46 synthesizes the final verified IR graph 24 into concrete models, ready for deployment and execution on a target platform.

Output Artifacts 62-64: Synthesis Module 46 generates deployable artifacts, including server configurations 62, client-side specifications 63, and API definitions 64, enabling seamless integration with external systems.

As an optional step, Inverse Compiler 48 receives the synthesized model from MoC 24 and reverse engineers the model back into the higher-level DSAIL 22 representation. This enables interative refinement and debugging of the DSAIL 22.

### Advantageous Features of the Present Invention

The following advantageous features are incorporated in the present invention:

In the case of software development domains and other domains for which computer simulations exist, a candidate solution can be modeled or implemented (e.g., via LLM 21 code generation) and run (executed), effectively providing a prototype solution to reduce the uncertainty of how a given system or subsystem might run.

The present invention provides a way to harness the sometimes overly enthusiastic creativity of generative AI (which causes hallucinations). A primary obstacle to the successful implementation of generative AI has been this hallucination problem; by incorporating a solver-driven model of computation, the present invention is able to formally verify AI-generated assertions, drastically increasing the confidence in AI-generated solutions.

The present invention allows automatic solution of complex problems, such as system design, across multiple domains of interest.

The automated nature of this dual (LLM 21 and solver 25) approach to generative AI means that a domain's design space can be automatically explored by tasking a separate LLM 21 to generate solutions to candidate domain problems, which are then analyzed and archived. These archived, pre-emptive solutions can then be used as a starting point for relevant future design problems, or as inspiration for new designs. This procedure in essence produces an “invention machine”. Beyond simple high-temperature LLM 21 generation, more advanced policies, such as what might be learned via Q/reinforcement learning, can be applied to guide the problem selection into the most fruitful directions, to combine the constraints of efficiently exploring the targeted domain space, while optimizing how much each new case supports and enhances the existing set of archived solutions.

Use of a specialized DSL 22 supports reasoning within large, complex scenarios, as well as those unique to particular business domains and research domains. For example, one implementation of the present invention comprises a DSL 22 that is focused on the domain of software architecture design. A well-designed DSL 22 makes expression of domain-relevant concepts easier than a general-purpose programming language such as Python. This helps AI engine 21 perform a higher-quality translation of the input natural language 31 into DSL 22, which the solver(s) 25 can then process directly.

Because the conversion of the input natural language into DSL 22 (FIG. 2, Step 2) involves the possibility of errors being introduced by the conversion, introduction of a DSL 22 makes it possible for User 2 to manually adjust the system input 31, while retaining the efficiency and creativity of AI engine 21.

The use of an abstracted model of computation (MoC) 24 that incorporates various solvers 25 provides a degree of flexibility and expandability not available when bound to a single solving approach. This is particularly illustrated by our use of dual SAT solvers 25, as illustrated in the above discussion of FIG. 4.

Fact sourcing from a set of external knowledge stores 26 allows User 2 to focus on the specifics of his or her immediate problem without also requiring the provision of background information from their domain with each request (and without requiring trusting AI engine 21 to include only non-hallucinated facts). Individual facts (or sets of facts from different sources) can be associated with metadata, establishing trust and provenance that can be utilized by MoC 24 when MoC 24 addresses the risks and benefits implied by believing any given fact.

The system and methods above have been described in general terms as an aid to understanding details of preferred embodiments of the present invention. In the description given herein, numerous specific details are provided, such as examples of components and/or methods, to provide a thorough understanding of embodiments of the present invention. Some features and benefits of the present invention are realized in such modes and are not required in every case. One skilled in the relevant art will recognize that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawing Figures can also be implemented in a more separated or integrated manner, or even removed or rendered as inoperable in certain cases, as is useful in accordance with a particular application.

Additionally, any directional arrows in the drawing Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract of the Disclosure, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the present description, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. The scope of the invention is to be determined solely by the following claims:

1. A system for improving the performance of artificial intelligence solutions, said system comprising:
a generative artificial intelligence engine adapted to convert natural language input into a domain-specific computer language containing logical statements and a proposed solution;
coupled to the domain-specific computer language, a model of computation module configured to analyze the domain-specific computer language; and
coupled to the model of computation module, at least one logical solver configured to assess the truth and feasibility of the logical statements; wherein
the at least one logical solver is further configured to provide feedback to the generative artificial intelligence engine to guide the engine in refining the proposed solution.

2. The system of claim 1 wherein the generative artificial intelligence engine is a large language model (LLM).

3. The system of claim 1 wherein each logical solver is from the group of solvers comprising SAT solvers and SMT solvers.

4. The system of claim 1 further comprising a DSL compiler configured to compile the domain-specific computer language into a form understandable by the model of computation module.

5. The system of claim 1 wherein the model of computation module comprises graphical information.

6. The system of claim 1 further comprising, coupled to the domain-specific computer language, a knowledge store containing a set of facts.

7. The system of claim 6 wherein the set of facts is organized into a plurality of tiers, where the tiers represent varying levels of confidence in the facts.

8. A method for improving generative artificial intelligence solutions, said method comprising the steps of an artificial intelligence engine:
receiving a natural language problem statement from a human user;
converting the natural language and a proposed solution into a domain-specific computer language; and
invoking a logical solver to perform truth and feasibility analysis of logic contained in the domain-specific computer language; wherein
the logical solver feeds said analysis back to the artificial intelligence engine for guiding the engine to improve the proposed solution.

9. The method of claim 8 wherein the domain-specific computer language is processed by a model of computation module comprising graphical information.

10. The method of claim 8 wherein the logical solver is a SAT or SMT solver.

11. The method of claim 8 further comprising the use of a knowledge store to augment the domain-specific computer language with a set of facts contained within the knowledge store.

12. The method of claim 11 wherein the facts are organized into a series of tiers, with the tiers representing varying degrees of confidence in the facts.

13. The method of claim 12 wherein the confidences are updated to accommodate new facts from new evidence or information using Bayesian inference and belief propagation.

14. The method of claim 8 wherein the method is repeated iteratively, and differences in results across iterations are captured as graph transformations.

15. The method of claim 14 wherein the graph transformations are stored in a transform library for subsequent use.

16. The method of claim 8 wherein:
the artificial intelligence engine breaks down the natural language problem statement into a set of discrete declarations; and
the set of declarations is converted by the artificial intelligence engine into the domain-specific computer language declaration by declaration.

17. The method of claim 8 further comprising the step of generating deployable artifacts suitable for use by external systems.

18. The method of claim 17 wherein the artifacts comprise at least one of server configurations, client-side specifications, and API definitions.

19. The method of claim 8 wherein outputs from the logical solver are subjected to checking, simulation, and synthesis.
